(19) United States
(12) Patent Application Publication
(10) Pub. No.: US 2008/0012359 A1
(43) Pub. Date: Jan. 17, 2008

(54) Magnetic action lock

(75) Inventor: Giovanni Aschieri, Torino (IT)

Correspondence Address: WEINER & BURT, P.C., 635 N US-23, POB 186, HARRISVILLE, MI, 48740, US

(73) Assignee: BONAITI SERRATURE S.p.A.

(21) Appl. No.: 11/825,359

(22) Filed: Jul. 7, 2007

(30) Foreign Application Priority Data
Jul. 12, 2006 (IT) MI2006A001352

(51) Int. Cl. E05C 17/56

(52) U.S. Cl. 292/251.5

(57) ABSTRACT

Magnetic action lock for inside doors, comprising a case fixed in a cavity of the impost wing of the door and a frontal closure plate, a strike in the jamb of the door which can be opposed to said frontal plate, a bolt and a mechanism for movement of said bolt, a pair of magnets inserted in the head of said bolt and in said strike respectively, wherein the position of opening of said bolt is obtained thanks to the concatenation of magnetic flows between the magnet in said bolt and the frontal closure plate, while the position of closure is achieved thanks to the attraction of the magnet in said bolt by the magnet in said strike, wherein the magnets have the poles oriented parallel to the axis of motion of said bolt, the case and the frontal closure plate are in ferromagnetic material and the strike is in a non-magnetic material.

### BACKGROUND OF THE INVENTION

### Description of the Prior Art

From Italian patent no. MI2003A0020117 a magnetic action lock for inside doors is known, provided with mechanisms for the actuation of an oscillating lever block for opening/closure of the lock hinged inside the case of the lock, with means of magnetic actuation of the oscillating block from the position of opening to the position of closure of the lock, these means being composed of a pair of magnets placed one in the bolt situated at the end of the oscillating block and the other inside the strike in the opposing jamb of the door.

### SUMMARY OF THE INVENTION

The object of the present invention is to provide a magnetic action lock wherein the bolt is maintained in a backward or forward position, i.e. of opening or closure of the lock respectively, thanks to the arrangement of two magnets inserted in the strike and in the bolt such as to have the orientation of the poles parallel to the axis of motion of the bolt and thanks to the manufacture of the box, of the cover, and of the frontal closure plate of the lock in a ferromagnetic material and of the strike in a non-magnetic material.

Another object of the present invention is that of providing a magnetic action lock not restrained by the arrangement of the weights and/or of the materials used inside the case, allowing a freedom of geometry and of arrangement of the same lock, extending the possible applications thereof.

A further object of the present invention is that of providing a magnetic action lock whose manufacture of the parts is simpler and the materials used are more economical.

All these objects are achieved by a magnetic action lock with the features disclosed according to the present invention.

The magnetic action lock for inside doors already known comprises a case of the lock fixed in a cavity of the impost wing of the door, a frontal closure plate of the case and a strike in the jamb of the door which can be opposed to said frontal plate. Inside the case of the lock an oscillating lever block for opening/closure of the lock is hinged rotarily in the plane of the impost. On the frontal closure plate an aperture is present for extraction of the head located at the end of the opening/closure block. The housing of the strike is located at this aperture to allow engaging of the head of the spring latch.

The oscillating block is supported in order to be able to rotate between one position with the head of the spring latch projecting from the frontal plate and corresponding to the closure of the lock, and a backward position with the head completely withdrawn in relation to the frontal plate and corresponding to the opening of the lock.

The magnetic actuation means comprise a pair of permanent magnets wherein the first magnet of said pair is attached in the head of the oscillating block and the second magnet of said pair is attached to the inner side of said strike in an opposable manner to said first permanent magnet.

In the embodiment already known, the magnets are arranged in such a way as to have orientation of the poles perpendicular to the axis of motion of the bolt, making the production of the frontal plates in zamak or another non-magnetic material obligatory, instead of the more economical and easier to process iron. If the frontal plate were made in iron, this material would interfere with the magnetic poles of the magnets, preventing proper working of the lock.

The major albeit not unique feature of this invention therefore provides for orientation of the strike and bolt magnets to be such that the poles have a parallel direction to the axis of motion of the bolt and are arranged so as to interact attractively if aligned one with the other, thus causing instantaneous and automatic closure of the lock. With this arrangement of the magnets the frontal plate of the lock has to be made in the more economical iron or in another ferromagnetic material. In this way, in rest conditions, i.e. when not aligned with the magnet of the strike, the magnet of the bolt is automatically positioned inside said box and has the pole corresponding to the front end of the bolt aligned with the frontal closure plate of the box to optimise the path of the magnetic flows, in such a way that the bolt is in a fully withdrawn position.

Another feature of the present embodiment is that the strike is made in a non-magnetic material in such a way as not to interfere with the magnet inside it. Said magnet is arranged in such a way as to have orientation of the poles parallel to the axis of motion of the bolt and such as to attract the magnet located in the bolt when the wing of the door is placed next to the jamb, causing the movement of the bolt inside the strike and therefore automatic closure of the lock.

### BRIEF DESCRIPTION OF DRAWINGS

These and other features will be made clearer on reading a preferred embodiment of the present invention, to be read by way of a non-limiting example of the more general concepts claimed.

The following description refers to the accompanying drawings, in which:

FIG. 1a is a side view of an embodiment of the lock according to the present invention;

FIGS. 2a, 2b and 2c are a view from above, a side view and a sectioned view respectively of a second preferred embodiment of the present invention;

FIGS. 3a, 3b and 3c are a side perspective view and a front view and a sectioned view respectively of a third preferred embodiment;

FIGS. 4a, 4b and 4c are a view in side perspective, a front view and a sectioned view respectively of a fourth preferred embodiment of the present invention.

### DESCRIPTION OF THE PREFERRED EMBODIMENTS

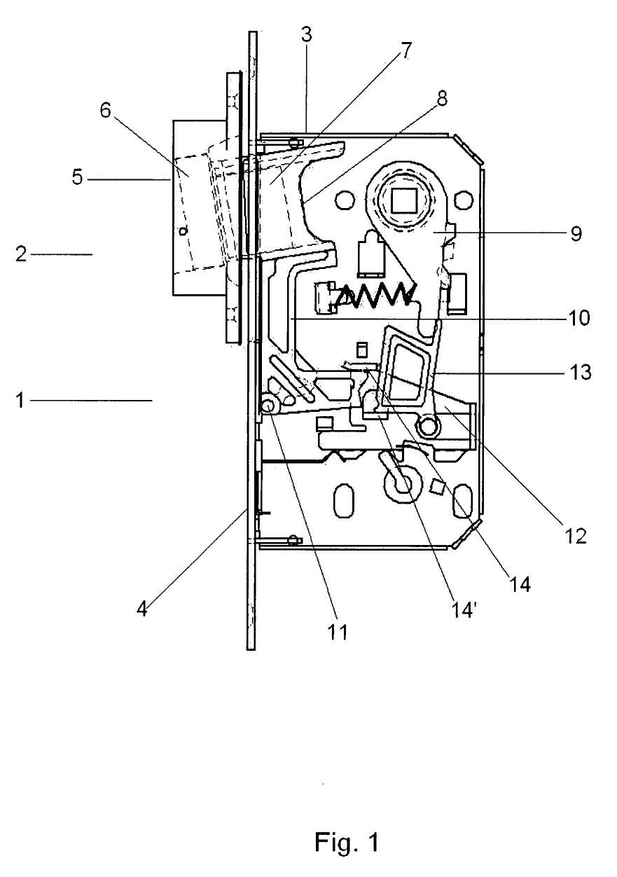

Referring to FIG. 1, the part 1 comprises a case or shell 3 and an elongated or frontal plate 4 for closure of the case 3, while the part of the jamb 2 comprises a strike 5 which is able to oppose the frontal plate 4 when the impost of the door is brought adjacent to the jamb. The cover, of a known type, which has the function of covering the case 3, is not shown here.

Inside the case 3 an L-shaped oscillating block 10 is hinged on the pin 11, said block 10 provided with an upper part 8 which acts as a bolt and whereon the first magnet of the pair 7 is inserted which, in a closure position, is inserted in the strike 5 wherein the second magnet 6 of the pair is positioned. The lower part of the block 10 is perpendicular to the upper part and is inserted between the fins 14 and 14′ of the bolt plate 12, as shown in FIG. 1a.

The mechanism for control of opening of the lock is of the type already known, comprising a handle pawl 9 whereto a handle, not shown here, is coupled. Said pawl 9 acts via an intermediate lever 13 which transmits motion to the bolt plate 12 which finally actuates the oscillating block 10, commanding opening thereof. Other, already known mechanisms are provided for return of the handle and blocking of the lock by means of a key.

In the present embodiment the magnet 7, inserted in the bolt 8, has the poles aligned in the direction of movement of the same bolt 8, as likewise the poles of the magnet 6 inserted in the strike 5 are aligned.

The frontal plate 4 is made in a ferromagnetic material like the case 3; this material forces a distribution of the magnetic field such that the magnet 7, once the block 10 has rotated into an opening position, remains fully inside the case, with the pole corresponding to the front end of the bolt fully inside the frontal plate 4, forcing said block 10 into this position until the door is once again brought adjacent to the jamb, causing the exiting of the bolt 8 due to the alignment and consequent attraction of the magnets 6 and 7.

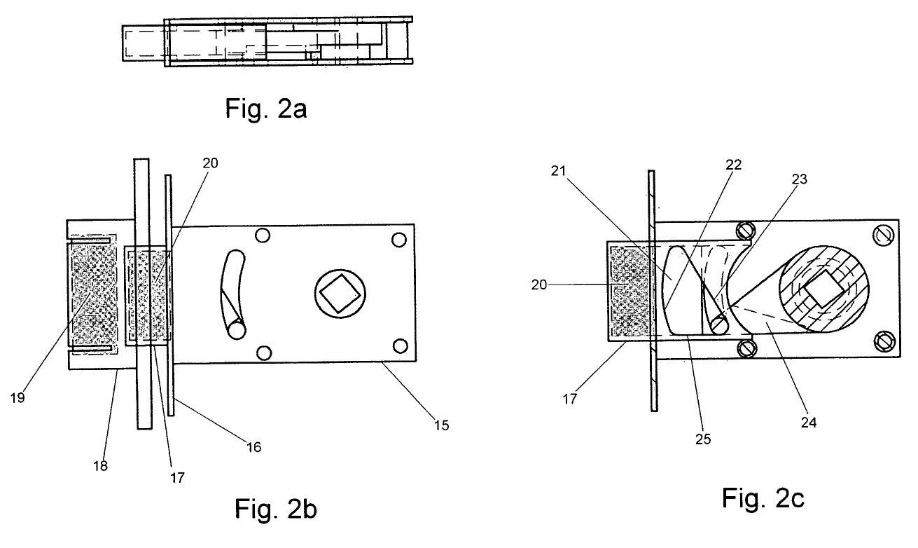

Referring to FIG. 2b, a second preferred embodiment of the present invention is shown. The lock is provided with a case 15 with the shape of a prism with a rectangular base inserted in the wing of the door, the frontal plate 16 is in a ferromagnetic material, like the case 15, and has an aperture for the exiting of the bolt 17 which is inserted in the corresponding strike 18, made in a non-magnetic material. Inside the bolt 17 the magnet 20 is housed with the poles parallel to the axis of motion of the bolt 17 and inside the strike 18 a magnet 19 is positioned with the poles parallel to the axis of motion of said bolt 17.

The bolt 17 is provided, as seen in FIG. 2c, in the part inside the case 15, with an extension which has, symmetrically on both vertical sides, a particular taper 21. This taper 21 has a lower horizontal part 25 the same length as the portion of bolt 17 which projects from the frontal plate 16, when said bolt 17 is in a closure position. Said taper 21 has a frontal part 22 with a circular profile which develops along almost the entire length of the bolt 17 and a slanting rear part 23 which joins with rectilinear profile the rear part of the lower portion 25 to the upper part of the front portion 22. The lever 24, positioned to the rear of the bolt 17, when it is rotated clockwise via a knob or key, not shown here, brings the bolt 17 into a backward position thanks to the special shape of the taper 21 and releases the strike 18, allowing opening of the door. Once the knob or key returns into the initial position, thanks to return mechanisms already known, the lever 24 also returns into the initial position shown in FIG. 2c; the bolt 17, instead, remains in a backward position in the case 15 as the shape of the taper 21 is such as to prevent the lever 24 from pushing said bolt 17 outwards and, an important feature of the device illustrated here, because the magnet 20 inside said bolt 17 forces it into this position for reasons of optimisation of the magnetic flow between said magnet, the case 15 and the frontal plate 16.

Only when the wing is adjacent to the jamb do the magnets in the bolt 17 and in the strike 18 attract each other, causing the exiting of said bolt 17 automatically, without the need for any manual control.

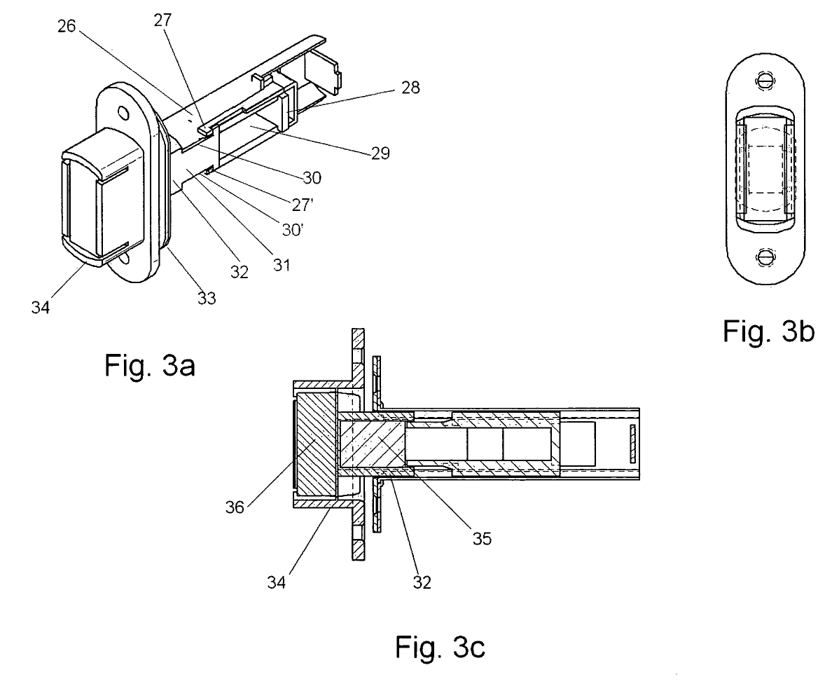

FIG. 3a shows the third preferred embodiment of the device. In this embodiment the case 26 has in its interior the bolt 32 which exits, in the closure position, from the frontal plate 33 to insert in the corresponding strike 34. In this case too the frontal plate 33 is made in a ferromagnetic material, like the case 26, while the strike 34 is made in a non-magnetic material.

The bolt 32 is provided in the rear part with two side fins 31 arranged vertically and parallel to the axis of motion of the bolt and, on these fins 31, notches 30 and 30′ are formed above and below, suitable for housing the hooks 27 and 27′ of the mobile member 29. This mobile member 29 is situated to the rear of the bolt 32 and hooks to the latter via said hooks 27 and 27′. When a pressure knob or a handle with actuation lever, both of the type already known and not shown here, pushes the rear part 28 of the mobile member 29 backwards, the hooks 27 and 27′ of said mobile member 29 draw the bolt 32 backwards, allowing opening of the door.

Since inside the bolt 32, as can be seen in FIG. 3c, the magnet 35 is positioned with the poles parallel to the axis of motion of the same bolt 32, once inside the case 26, the configuration of the magnetic field is such that the magnet 35 forces the bolt 32 to remain in a backward position. Once the handle has returned into the initial position, the mobile member 29 also returns into the initial position thanks to a spring, not shown here, placed between the external rear part of the mobile member 28 and the internal rear part of the case 26. The notches 30 and 30′ are such that the hooks 27 and 27′ can only pull the bolt 32 inside the case 26 and not push it outwards.

The insertion of the bolt 32 in the strike 34 takes place when the wing of the door is adjacent to the jamb and the magnets 35 and 36, placed in the bolt 32 and in the strike 34 respectively with the poles oriented parallel to the axis of motion of the bolt, are aligned and attract each other, causing the automatic closure of the lock.

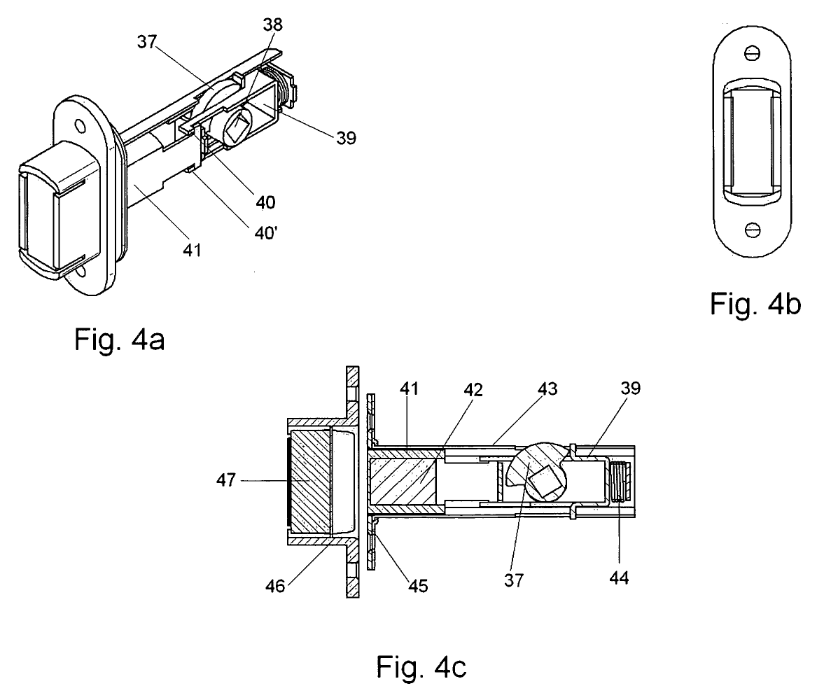

FIG. 4a shows the fourth preferred embodiment of the present invention.

The present embodiment differs from the previous one merely due to the presence of the cam 37, made to be actuated by a lever or knob handle with a square drive shaft, also of the type already known. Rotation of the handle hinged to the hole 38 makes the cam 37 rotate clockwise which moves the mobile member 39 backwards. The mobile member 39 hooks with the hooks 40 and 40′ the rear part of the bolt 41 which is withdrawn. Once the bolt 41 has withdrawn, the magnet 42, in its interior, shown in FIG. 4c, with the poles oriented parallel to the axis of motion of the bolt 41, for the reasons described previously, forces said bolt 41 to remain inside the case 43 made in a ferromagnetic material, like the frontal plate 45. The spring 44 placed between the external rear part of the mobile member 39 and the internal rear part of the case 43 pushes said mobile member 39 forwards and rotates in an anticlockwise direction the handle hinged in the hole 38, returning it into the initial position.

The bolt 41 remains inside the case 43 until the wing of the door is brought adjacent to the jamb and the magnet 42 inside the bolt 41 is attracted by the magnet 47 inside the strike 46, allowing automatic closure of the lock.

The arrangement of the magnets in the bolt and in the strike with orientation of the respective poles parallel to the axis of motion according to the present invention and the composition of case, cover and frontal closure plate in a ferromagnetic material, and of the strike in a non-magnetic material, make the production of a magnetic action lock thus simple and economical and in said lock the bolt is withdrawn by manual actuation, the remaining of said bolt inside the case inserted in the wing of the door being guaranteed by concatenation of the magnetic field of the magnet inserted in said bolt with the frontal closure plate of the lock, and also with the case and cover, and the exiting of said bolt only taking place when said wing is brought adjacent to the corresponding jamb, in whose interior said strike is inserted, causing the alignment and the attraction of the respective magnets, automatically closing the lock.

The mechanism which allows the bolt to remain in a backward position or to be made to move forwards when the wing is brought adjacent to the door is moreover based on the sole effect of the magnetic fields, allowing ample design flexibility, not being restrained by effects of weights or special geometric restrictions.

What is claimed is:

1. Magnetic action lock, comprising a case, a cover and a frontal closure plate of the case inserted in the impost, a strike which can be opposed to the frontal plate when the impost of the door is brought adjacent to the jamb, a pair of magnets, a bolt inside whereof the first magnet of the pair is inserted, which in the closure position is inserted in the strike in which the second magnet of the pair is positioned, a mechanism for opening/closure of the lock and mechanisms for return of the handle, characterised in that the magnet in the bolt and the magnet in the strike have the poles aligned in the direction parallel to the axis of movement of the bolt, in that the frontal plate, the case and the cover are made in a ferromagnetic material and the strike is made in a non-magnetic material.

2. Magnetic action lock according to the previous claim, characterised in that the position of opening of the bolt is maintained through the effect of the magnetic field generated by the magnet which concatenates with the frontal plate, possibly implemented by the reciprocal configuration of the other components of the lock made in a ferromagnetic material.

3. Magnetic action lock according to the previous claims, characterised in that the position of closure of the bolt is achieved automatically when the door is brought adjacent to the jamb and the magnet inside said bolt is aligned with the magnet inside the strike and is attracted by it, causing exiting of said bolt and closure of the lock.

4. Magnetic action lock according to previous claims, comprising in a first embodiment a mechanism of opening/closure and a mechanism for blocking of the lock by means of a key, both of the type already known, characterised in that it is provided with an L-shaped oscillating block hinged on a pin, said block being provided with an upper part which acts as a bolt and whereon the first magnet of the pair is inserted, and the second magnet of the pair being inserted in the respective strike.

5. Magnetic action lock according to claims 1, 2 and 3, characterised in that in a second embodiment it is provided with a case shaped like a prism with rectangular base inserted in the wing of the door, a frontal plate wherein there is an aperture for exiting of the bolt which is inserted in the corresponding strike inserted in the jamb, said bolt having in its interior a magnet whose poles are parallel to the axis of motion of the bolt itself and said strike having in its interior a magnet, said bolt provided with an extension which has in the part inside the case a taper formed on at least one side of said extension and, positioned to the rear of said bolt, there is a lever whose end inserts in said taper.

6. Magnetic action lock according to the previous claim, characterised in that said taper has a lower horizontal part of the same length as the portion of bolt which projects from the frontal plate when said bolt is in closure conditions, has a front part with a circular profile which develops along almost the entire height of the bolt and a slanted rear part which joins with a rectilinear profile the rear part of the lower portion to the upper part of the front portion.

7. Magnetic action lock according to claims 5 and 6, characterised in that the lever, when it is rotated clockwise via a handle or key of the type already known, hinged thereon, brings said bolt in a backward position thanks to the shape of said taper, releasing the strike and thus allowing opening of the door.

8. Magnetic action lock according to claims 5, 6 and 7, characterised in that once said knob or said key is returned into the initial position, thanks to return mechanisms already known, the lever is also rotated into the initial position, while the bolt remains withdrawn in the case according to claim 2.

9. Magnetic action lock according to claims 1, 2 and 3, characterised in that in a third embodiment the bolt is provided in the rear part with at least one side fin arranged vertically and parallel to the axis of motion of said bolt, and in that on said fin there is at least one notch above or below.

10. Magnetic action lock according to the previous claim, characterised in that at the rear of said bolt there is a mobile member provided with at least one hook which is inserted in said notch.

11. Magnetic action lock according to claims 9 and 10, characterised in that the action of a pressure knob of the type already known which acts on the rear part of the mobile member, pushing it backwards, causes drawing of said bolt towards the inner part of the case by said hooks, allowing opening of the door.

12. Magnetic action lock according to claims 9 and 10 characterised in that in a fourth embodiment a cam is hinged inside the mobile member and which, rotated, pushes said member (39) inside the case, causing movement of the bolt and opening of the lock.
